(19) United States
(12) Patent Application Publication
(10) Pub. No.: US 2025/0057118 A1
(43) Pub. Date: Feb. 20, 2025

(54) SLIDABLE PET TAG WITH IDENTIFICATION

(71) Applicant: TAILR, LLC, Sugarcreek, OH (US)

(72) Inventors: Paul MILLER, Sugarcreek, OH (US); Phillip COLETTI, Strasburg, OH (US)

(21) Appl. No.: 18/805,722

(22) Filed: Aug. 15, 2024

Related U.S. Application Data
(60) Provisional application No. 63/519,683, filed on Aug. 15, 2023.

(51) Int. Cl. A01K 11/00

(52) U.S. Cl. CPC A01K 11/006

(57) ABSTRACT

A pet identification tag is described herein, including a front, wherein the front contains an electronic code, wherein the electronic code contains information about an associated pet, a back, a top, a bottom, a first attachment tab, wherein the first attachment tab has a first end and a second end, a second attachment tab, wherein the second attachment tab has a first end and a second end, a third attachment tab, wherein the third attachment tab has a first end and a second end, and a fourth attachment tab, wherein the fourth attachment tab has a first end and a second end, wherein the first and second attachment tabs are attached to the top of the tag, and the third and fourth attachment tabs are attached to the bottom of the tag.

### I. BACKGROUND

This application claims priority to U.S. Ser. No. 63/519,683, filed Aug. 15, 2023, entitled Slidable Pet Tag With Identification, the contents of which are incorporated herein by reference. The present teaching is directed to a pet tag. More specifically, the present teaching is directed to a slidable pet tag with electronic identification.

Pet owners have been utilizing tags to identify their pets for hundreds of years. They are helpful in quickly identifying the pet, the pet owner, as well as an owner address. In recent years, electronic devices have been used to identify and track pets. Microchips have been used to track pets, and other animals, since the mid-1980s. In pets, the chips are usually inserted below the skin at the back of the neck between the shoulder blades on the dorsal midline.

A QR code (quick-response code) is a type of two-dimensional matrix barcode. A barcode is a machine-readable optical image that contains information specific to the labelled item. In practice, QR codes contain data for a locator, an identifier, and a website visitor tracking. To efficiently store data, QR codes use four standardized modes of encoding (i) numeric, (ii) alphanumeric, (iii) byte or binary, and (iv) kanji.

A QR code consists of black squares arranged in a square grid on a white background, including some fiducial markers, which can be read by an imaging device such as a camera, and processed using Reed-Solomon error correction until the image can be appropriately interpreted. The required data is then extracted from patterns that are present in both horizontal and vertical components of the image.

A digital profile can be created, along with a QR tag for a pet. Not only can the pet owner store important information about their pet, but also have peace of mind knowing a GPS locating service allows quick and easy recovery if the pet ever gets lost.

### II. SUMMARY

This summary is provided to introduce a selection of concepts in a simplified form that are further described below in the Detailed Description. This summary is not intended to identify key factors or essential features of the claimed subject matter, nor is it intended to be used to limit the scope of the claimed subject matter.

The present teaching describes a new, easy slide-on pet tag. The tag can be easily placed on the pet collar, without having to remove the collar from the pet.

One aspect of the present teaching allows for placement of a tag on a pet collar, without having to thread a hole on the tag through a metal ring.

Still other benefits and advantages of the present subject matter will become apparent to those skilled in the art to which it pertains upon a reading and understanding of the following detailed specification.

### III. BRIEF DESCRIPTION OF THE DRAWINGS

The disclosure may take physical form in certain parts and arrangement of parts, aspects of which will be described in detail in this specification and illustrated in the accompanying drawings which form a part hereof and wherein:

FIG. 1 shows a front view of a collar and tag;

FIG. 2 shows a back view of the collar and tag;

FIG. 3 shows a back view of another aspect of the collar and tag;

FIG. 4 shows a back view of another aspect of the collar and tag;

FIG. 5 shows a side view of the tag;

FIG. 6 shows a front view of the tag;

FIG. 7 shows a back view of the tag;

FIG. 8A shows a side view of the tag; and

FIG. 8B shows another side view of the tag.

### IV. DETAILED DESCRIPTION

Referring now to the drawings wherein the showings are for purposes of illustrating aspects of the disclosure only and not for purposes of limiting the same, and wherein like reference numerals are understood to refer to like components.

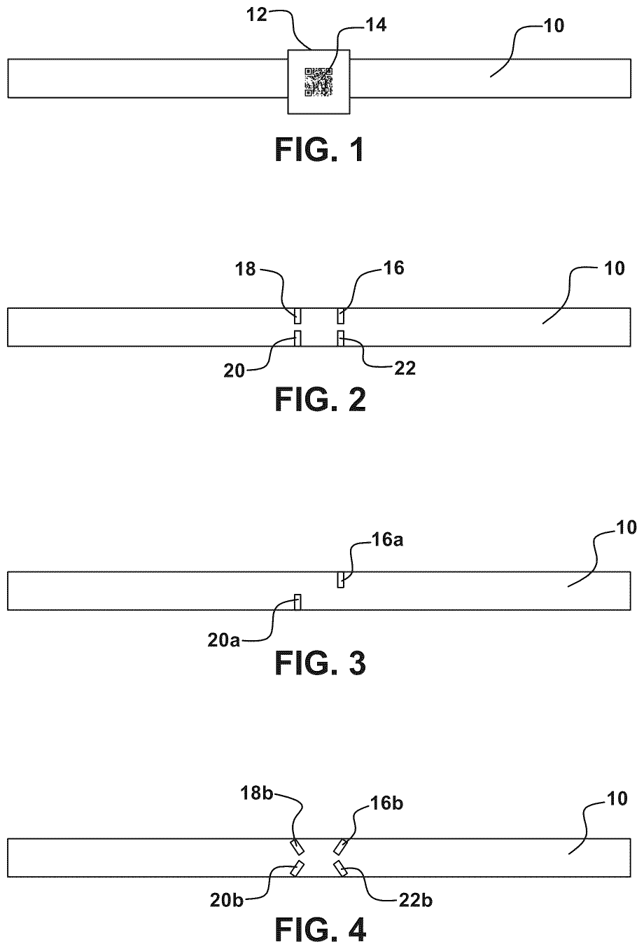

FIGS. 1-8 show a pet collar 10, an identification tag 12, an electronic code 14, attachment tabs 16, 18, 20, 22, flexible attachment mechanism 24, and attachment tab 26.

With continuing reference to FIGS. 1-8, the identification tag 12 attaches to the collar 10 via the attachment tabs 16, 18, 20, 22. In one aspect of the present teaching, the top portion of the collar 10 can be slid into the attachment tabs 16, 18 and then the bottom portion of the collar 10 can be slid into the attachment tabs 20, 22. The identification tag 12 can just as easily be removed from the collar 10 by removing the attachment tabs 16, 18, 20, 22 from the top and bottom portions of the collar 10. In another aspect of the present teaching, the identification tag 12 can be slid onto the collar 10 at the end of the collar 10, by sliding the end of the collar through the attachment tabs 16, 18, 20, 22.

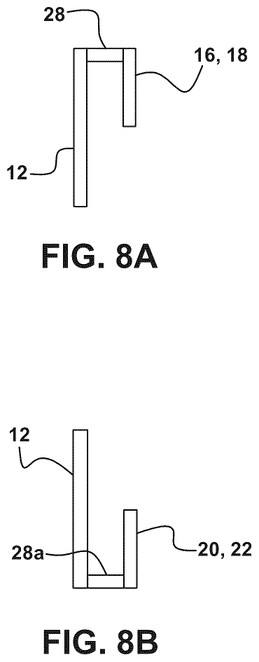

With continuing reference to FIGS. 1-8, the identification tag 12 can be made of metal, plastic, wood, or any other type of material chosen using sound engineering judgment. The attachment tabs 16, 18, 20, 22 can similarly be made of the same materials. FIG. 8A shows a side view of the identification tag 12 with top bar 28, which connects the attachment tabs 16, 18 to the top of the identification tag 12. FIG. 8B shows a side view of the identification tag 12 with bottom bar 28a, which connects the attachment tabs 20, 22 to the bottom of the identification tag 12.

With reference to FIG. 3, a different aspect of the present teaching is shown. In FIG. 3, only two attachment tabs 16a, 20a are shown, one attachment tab 16a on the top of the collar 10, and one attachment tab 20a on the bottom portion of the collar 10. The identification tag 12 attaches to the collar 10 via the attachment tabs 16a, 20a. In one aspect of the present teaching, the top portion of the collar 10 can be slid into the attachment tab 16a and then the bottom portion of the collar 10 can be slid into the attachment tab 20a. The identification tag 12 can just as easily be removed from the collar 10 by removing the attachment tabs 16a, 20a from the top and bottom portions of the collar 10. In another aspect of the present teaching, the identification tag 12 can be slid onto the collar 10 at the end of the collar 10, by sliding the end of the collar through the attachment tabs 16a, 20a.

With reference to FIG. 4, a different aspect of the present teaching is shown. In FIG. 4, attachment tabs 16b, 18b, 20b, 22b are shown, wherein the attachment tabs 16b, 18b, 20b, 22b are angled inwardly. The identification tag 12 attaches to the collar 10 via the attachment tabs 16b, 18b, 20b, 22b. In one aspect of the present teaching, the top portion of the collar 10 can be slid into the attachment tabs 16b, 18b and then the bottom portion of the collar 10 can be slid into the attachment tabs 20b, 22b. The identification tag 12 can just as easily be removed from the collar 10 by removing the attachment tabs 16b, 18b, 20b, 22b from the top and bottom portions of the collar 10. In another aspect of the present teaching, the identification tag 12 can be slid onto the collar 10 at the end of the collar 10, by sliding the end of the collar through the attachment tabs 16b, 18b, 20b, 22b. It is to be understood that the number of attachment tabs is not limited in number. Any number of attachment tabs can be used, as long as the attachment tabs hold the tag 12 onto the collar 10. It is also to be understood that the attachment tabs can be rigid, wherein the opening between the attachment tabs and the tag 12 would be of a distance such that the collar 10 would be a tight fit between the tag 12 and the attachment tabs. The attachment tabs could also be made of a resilient material, such that the collar 10 would move them slightly out of the way, and the attachment tabs would flex back and hold the tag 12 in place.

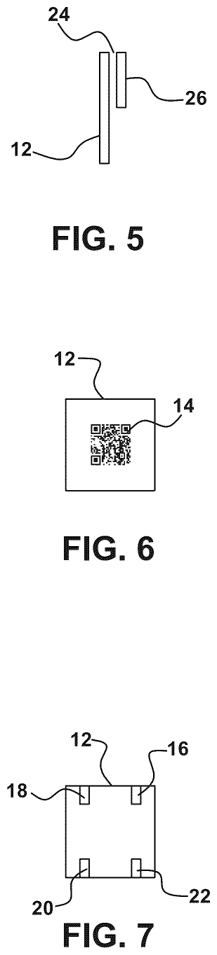

With reference now to FIG. 5, a side view of the tag 12, showing another aspect of the present teaching. The tag 12 has an attachment tab 26 attached to the top portion of the tag 12 by a flexible mechanism 24. The flexible mechanism 24 could be a spring or a hinge, or any other device that would allow the attachment tab 26 to be moved away from and toward the tag 12.

With reference now to FIGS. 1 and 6, the electronic code 14 is shown on the front of the tag 12. The electronic code, which can be a QR code, or any other type of electronic code for storing data, contains information regarding the pet, such as name, breed, owner's name, address, vaccine record, health record, etc.

Clause 1—A pet identification tag is described herein, including a front, wherein the front contains an electronic code, wherein the electronic code contains information about an associated pet, a back, a top, a bottom, a first attachment tab, wherein the first attachment tab has a first end and a second end, a second attachment tab, wherein the second attachment tab has a first end and a second end, a third attachment tab, wherein the third attachment tab has a first end and a second end, and a fourth attachment tab, wherein the fourth attachment tab has a first end and a second end, wherein the first and second attachment tabs are attached to the top of the tag, and the third and fourth attachment tabs are attached to the bottom of the tag, wherein the attachment tabs are attached to the tag at the first end of the attachment tabs, wherein the second ends of the attachment tabs are spaced apart from each other, wherein the first and second ends of the attachment tabs are substantially parallel to the top and the bottom of the tag, wherein the attachment tabs are configured to slide along an associated pet collar.

Clause 2—A pet identification tag including a front, a back, a top, a bottom, at least one attachment tab having a first end and a second end, wherein the at least attachment tab is configured to slide along an associated pet collar, and a top or bottom bar, wherein the top or bottom bar has a first end and a second end, wherein the first end of the top or the bottom bar is connected to the top or the bottom of the tag, wherein the second end of the top or bottom bar is connected to the first end of the at least one attachment tab, wherein the at least one attachment tab is substantially parallel to the back of the tag, wherein the top or the bottom bar is width of the associated pet collar.

Clause 3—The pet identification tag of clause 2, wherein the at least one attachment tab is at least two attachment tabs.

Clause 4—The pet identification tag of clauses 2 or 3, wherein the at least two attachment tabs are a first attachment tab and a second attachment tab, wherein the first attachment tab is connected to the top of the tag by the top bar and the second attachment tab is connected to the bottom of the tag by the bottom bar.

Clause 5—The pet identification tag of clauses 2-4, wherein the first attachment tab extends downwardly from the top of the tag about halfway down the associated pet collar and the second attachment tab extends upwardly from the bottom of the tag about halfway up the associated pet collar.

Clause 6—The pet identification tag of clauses 2-5, wherein the front of the tag contains an electronic code, wherein the electronic code contains information about an associated pet.

Clause 7—The pet identification tag of clauses 2-6, wherein the least two attachment tabs is at least four attachment tabs, further comprising a third attachment tab and a fourth attachment tab, wherein the third attachment tab is connected to the top of the tag by a second top bar and the fourth attachment tab is connected to the bottom of the tag by a second bottom bar.

Clause 8—The pet identification tag of clauses 2-7, wherein the third attachment tab extends downwardly from the top of the tag about halfway down the associated pet collar and the fourth attachment tab extends upwardly from the bottom of the tag about halfway up the associated pet collar.

Clause 9—The pet identification tag of clauses 2-4, wherein the first attachment tab extends downwardly from the top of the tag at an angle down the associated pet collar and the second attachment tab extends upwardly from the bottom of the tag at an angle up the associated pet collar, wherein the angle of the first attachment tab and the angle of the second attachment tab are between about 20 degrees and about 60 degrees.

Clause 10—The pet identification tag of clauses 2-4 or 9, wherein the least two attachment tabs is at least four attachment tabs, further comprising a third attachment tab and a fourth attachment tab, wherein the third attachment tab is connected to the top of the tag by the second top bar and the fourth attachment tab is connected to the bottom of the tag by the second bottom bar, wherein the third attachment tab extends downwardly from the top of the tag at an angle down the associated pet collar and the fourth attachment tab extends upwardly from the bottom of the tag at an angle up the associated pet collar, wherein the angle of the third attachment tab and the angle of the fourth attachment tab are between about 20 degrees and about 60 degrees.

Clause 11—A pet identification tag including a front, a back, a top, a bottom, at least one attachment tab having a first end and a second end, wherein the at least attachment tab is configured to slide along an associated pet collar, and a first and second flexible mechanism, wherein the first and second flexible mechanisms have a first end and a second end, wherein the first end of the first or the second flexible mechanism is connected to the top or the bottom of the tag, wherein the second end of the first or the second flexible mechanism is connected to the first end of the at least one attachment tab, wherein the at least one attachment tab is substantially parallel to the back of the tag.

Clause 12—The pet identification tag of clause 11, wherein the at least one attachment tab is at least two attachment tabs.

Clause 13—The pet identification tag of clauses 11 or 12, wherein the at least two attachment tabs are a first attachment tab and a second attachment tab, wherein the first attachment tab is connected to the top of the tag by the first flexible mechanism and the second attachment tab is connected to the bottom of the tag by the second flexible mechanism.

Clause 14—The pet identification tag of clauses 11-13, wherein the first attachment tab extends downwardly from the top of the tag about halfway down the associated pet collar and the second attachment tab extends upwardly from the bottom of the tag about halfway up the associated pet collar.

Clause 15—The pet identification tag of clauses 11-14, wherein the front of the tag contains an electronic code, wherein the electronic code contains information about an associated pet.

Clause 16—The pet identification tag of clauses 11-15, wherein the least two attachment tabs is at least four attachment tabs, further comprising a third attachment tab and a fourth attachment tab, wherein the third attachment tab is connected to the top of the tag by a third flexible mechanism and the fourth attachment tab is connected to the bottom of the tag by a fourth flexible mechanism.

Clause 17—The pet identification tag of clauses 11-16, wherein the third attachment tab extends downwardly from the top of the tag about halfway down the associated pet collar and the fourth attachment tab extends upwardly from the bottom of the tag about halfway up the associated pet collar.

Clause 18—The pet identification tag of clauses 11-13, wherein the first attachment tab extends downwardly from the top of the tag at an angle down the associated pet collar and the second attachment tab extends upwardly from the bottom of the tag at an angle up the associated pet collar, wherein the angle of the first attachment tab and the angle of the second attachment tab are between about 20 degrees and about 60 degrees.

Clause 19—The pet identification tag of clauses 11-13 or 18, wherein the least two attachment tabs is at least four attachment tabs, further comprising a third attachment tab and a fourth attachment tab, wherein the third attachment tab is connected to the top of the tag by a third flexible mechanism and the fourth attachment tab is connected to the bottom of the tag by a fourth flexible mechanism, wherein the third attachment tab extends downwardly from the top of the tag at an angle down the associated pet collar and the fourth attachment tab extends upwardly from the bottom of the tag at an angle up the associated pet collar, wherein the angle of the third attachment tab and the angle of the fourth attachment tab are between about 20 degrees and about 60 degrees.

Numerous aspects have been described, hereinabove. It will be apparent to those skilled in the art that the above methods and devices may incorporate changes and modifications without departing from the general scope of the present teaching. It is intended to include all such modifications and alterations in so far as they come within the scope of the appended claims or the equivalents thereof.

Having thus described the disclosure, it is now claimed:

I/We claim:

1. A pet identification tag, the pet identification tag comprising:
a front, wherein the front contains an electronic code, wherein the electronic code contains information about an associated pet;
a back;
a top;
a bottom;
a first attachment tab, wherein the first attachment tab has a first end and a second end;
a second attachment tab, wherein the second attachment tab has a first end and a second end;
a third attachment tab, wherein the third attachment tab has a first end and a second end; and
a fourth attachment tab, wherein the fourth attachment tab has a first end and a second end, wherein the first and second attachment tabs are attached to the top of the tag, and the third and fourth attachment tabs are attached to the bottom of the tag, wherein the attachment tabs are attached to the tag at the first end of the attachment tabs, wherein the second ends of the attachment tabs are spaced apart from each other, wherein the first and second ends of the attachment tabs are substantially parallel to the top and the bottom of the tag, wherein the attachment tabs are configured to slide along an associated pet collar.

2. A pet identification tag comprising:
a front;
a back;
a top;
a bottom;
at least one attachment tab having a first end and a second end, wherein the at least attachment tab is configured to slide along an associated pet collar; and
a top or bottom bar, wherein the top or bottom bar has a first end and a second end, wherein the first end of the top or the bottom bar is connected to the top or the bottom of the tag, wherein the second end of the top or bottom bar is connected to the first end of the at least one attachment tab, wherein the at least one attachment tab is substantially parallel to the back of the tag, wherein the top or the bottom bar is width of the associated pet collar.

3. The pet identification tag of claim 2, wherein the at least one attachment tab is at least two attachment tabs.

4. The pet identification tag of claim 3, wherein the at least two attachment tabs are a first attachment tab and a second attachment tab, wherein the first attachment tab is connected to the top of the tag by the top bar and the second attachment tab is connected to the bottom of the tag by the bottom bar.

5. The pet identification tag of claim 4, wherein the first attachment tab extends downwardly from the top of the tag about halfway down the associated pet collar and the second attachment tab extends upwardly from the bottom of the tag about halfway up the associated pet collar.

6. The pet identification tag of claim 5, wherein the front of the tag contains an electronic code, wherein the electronic code contains information about an associated pet.

7. The pet identification tag of claim 6, wherein the least two attachment tabs is at least four attachment tabs, further comprising a third attachment tab and a fourth attachment tab, wherein the third attachment tab is connected to the top of the tag by a second top bar and the fourth attachment tab is connected to the bottom of the tag by a second bottom bar.

8. The pet identification tag of claim 7, wherein the third attachment tab extends downwardly from the top of the tag about halfway down the associated pet collar and the fourth attachment tab extends upwardly from the bottom of the tag about halfway up the associated pet collar.

9. The pet identification tag of claim 4, wherein the first attachment tab extends downwardly from the top of the tag at an angle down the associated pet collar and the second attachment tab extends upwardly from the bottom of the tag at an angle up the associated pet collar, wherein the angle of the first attachment tab and the angle of the second attachment tab are between about 20 degrees and about 60 degrees.

10. The pet identification tag of claim 9, wherein the least two attachment tabs is at least four attachment tabs, further comprising a third attachment tab and a fourth attachment tab, wherein the third attachment tab is connected to the top of the tag by the second top bar and the fourth attachment tab is connected to the bottom of the tag by the second bottom bar, wherein the third attachment tab extends downwardly from the top of the tag at an angle down the associated pet collar and the fourth attachment tab extends upwardly from the bottom of the tag at an angle up the associated pet collar, wherein the angle of the third attachment tab and the angle of the fourth attachment tab are between about 20 degrees and about 60 degrees.

11. A pet identification tag comprising:
a front;
a back;
a top;
a bottom;
at least one attachment tab having a first end and a second end, wherein the at least attachment tab is configured to slide along an associated pet collar; and
a first and second flexible mechanism, wherein the first and second flexible mechanisms have a first end and a second end, wherein the first end of the first or the second flexible mechanism is connected to the top or the bottom of the tag, wherein the second end of the first or the second flexible mechanism is connected to the first end of the at least one attachment tab, wherein the at least one attachment tab is substantially parallel to the back of the tag.

12. The pet identification tag of claim 11, wherein the at least one attachment tab is at least two attachment tabs.

13. The pet identification tag of claim 12, wherein the at least two attachment tabs are a first attachment tab and a second attachment tab, wherein the first attachment tab is connected to the top of the tag by the first flexible mechanism and the second attachment tab is connected to the bottom of the tag by the second flexible mechanism.

14. The pet identification tag of claim 13, wherein the first attachment tab extends downwardly from the top of the tag about halfway down the associated pet collar and the second attachment tab extends upwardly from the bottom of the tag about halfway up the associated pet collar.

15. The pet identification tag of claim 14, wherein the front of the tag contains an electronic code, wherein the electronic code contains information about an associated pet.

16. The pet identification tag of claim 15, wherein the least two attachment tabs is at least four attachment tabs, further comprising a third attachment tab and a fourth attachment tab, wherein the third attachment tab is connected to the top of the tag by a third flexible mechanism and the fourth attachment tab is connected to the bottom of the tag by a fourth flexible mechanism.

17. The pet identification tag of claim 16, wherein the third attachment tab extends downwardly from the top of the tag about halfway down the associated pet collar and the fourth attachment tab extends upwardly from the bottom of the tag about halfway up the associated pet collar.

18. The pet identification tag of claim 13, wherein the first attachment tab extends downwardly from the top of the tag at an angle down the associated pet collar and the second attachment tab extends upwardly from the bottom of the tag at an angle up the associated pet collar, wherein the angle of the first attachment tab and the angle of the second attachment tab are between about 20 degrees and about 60 degrees.

19. The pet identification tag of claim 18, wherein the least two attachment tabs is at least four attachment tabs, further comprising a third attachment tab and a fourth attachment tab, wherein the third attachment tab is connected to the top of the tag by a third flexible mechanism and the fourth attachment tab is connected to the bottom of the tag by a fourth flexible mechanism, wherein the third attachment tab extends downwardly from the top of the tag at an angle down the associated pet collar and the fourth attachment tab extends upwardly from the bottom of the tag at an angle up the associated pet collar, wherein the angle of the third attachment tab and the angle of the fourth attachment tab are between about 20 degrees and about 60 degrees.
